(19) United States
(12) Patent Application Publication
(10) Pub. No.: US 2023/0097089 A1
(43) Pub. Date: Mar. 30, 2023

(54) SOUND SOURCE POSITION DETERMINATION DEVICE, SOUND SOURCE POSITION DETERMINATION METHOD, AND PROGRAM

(71) Applicant: NIPPON TELEGRAPH AND TELEPHONE CORPORATION, Tokyo (JP)

(72) Inventor: Kazunori KOBAYASHI, Tokyo (JP)

(73) Assignee: NIPPON TELEGRAPH AND TELEPHONE CORPORATION, Tokyo (JP)

(21) Appl. No.: 17/911,393

(22) PCT Filed: Mar. 18, 2020
(86) PCT No.: PCT/JP2020/012062

§ 371 Date: Sep. 13, 2022

(51) Int. Cl. G10L 15/20; H04R 3/00; H04R 1/40

(52) U.S. Cl. CPC G10L 15/20; H04R 3/005; H04R 1/406; H04R 2499/13; H04R 2430/20

(57) ABSTRACT

The sound source position determination device includes a first microphone that is disposed at a position at which sound arriving from inside the closed space is likely to be picked up, a second microphone that is disposed at a position at which sound arriving from outside the closed space is likely to be picked up, a power ratio calculation unit that calculates a power ratio of an acoustic signal picked up by the first microphone during a predetermined time section to an acoustic signal picked up by the second microphone during the time section, and a determination unit that determines whether sound picked up during the time section came from inside or outside the closed space, based on the power ratio.

### TECHNICAL FIELD

The present invention relates to a sound source position determination device, a sound source position determination method, and a program for determining the position of a sound source.

### BACKGROUND ART

Conventionally, techniques for installing a microphone in a vehicle and using it for communication inside and outside the vehicle or as an input device of a voice assistant have been widely carried out (NPL 1).

### CITATION LIST

### Non Patent Literature

[NPL 1] Nippon Telegraph and Telephone Corporation, “Speech enhancement technology for in-car communication”, [online], [retrieved on Mar. 12, 2020], Internet<URL:http://www.ntt.co.jp/RD/active/201802/en/pdf_eng/F10_e.pdf>

### SUMMARY OF THE INVENTION

### Technical Problem

However, if the noise barrier performance of a vehicle is low, when sound emitted from outside the vehicle is transmitted to the inside of the vehicle without being sufficiently attenuated, and is picked up by a microphone installed in the vehicle, for example, an unintended instruction may be given to a voice assistant, thereby affecting the above-mentioned communication. Moreover, for example, when a microphone is used as a sensor for automated driving or the like, incorrect sensor data may be picked up as a result of sound emitted inside the vehicle being regarded as sound emitted outside the vehicle. That is to say, when a microphone installed in a vehicle is to be used, it is necessary to determine whether the sound source of picked-up sound is positioned inside or outside the vehicle.

In view of this, an object of the present invention is to provide a sound source position determination device that can determine whether a sound source corresponding to an acoustic signal picked up by a microphone installed in a closed space of a vehicle or the like is positioned inside or outside the closed space.

### Means for Solving the Problem

A sound source position determination device according to the present invention includes a first microphone, a second microphone, a power ratio calculation unit, and a determination unit.

The first microphone is disposed at a position at which sound arriving from inside a closed space is likely to be picked up. The second microphone is disposed at a position at which sound arriving from outside the closed space is likely to be picked up. The power ratio calculation unit calculates a power ratio of an acoustic signal picked up by the first microphone during a predetermined time section to an acoustic signal picked up by the second microphone during the predetermined time section, the predetermined time section being a time section in which signals are handled as signals picked up at the same time. The determination unit determines, based on the power ratio, whether the sound picked up during the time section came from inside or outside the closed space.

### Effects of the Invention

With a sound source position determination device according to the present invention, it is possible to determine whether a sound source corresponding to an acoustic signal picked up by a microphone installed in a closed space is positioned inside or outside of the closed space.

### BRIEF DESCRIPTION OF DRAWINGS

FIG. 1 is a diagram showing an arrangement example of microphones of each sound source position determination device according to first to fourth embodiments.

FIG. 2 is a block diagram showing a configuration of the sound source position determination device according to the first embodiment.

FIG. 3 is a flowchart showing operations of the sound source position determination device according to the first embodiment.

FIG. 4 is a block diagram showing the configuration of the sound source position determination device according to the second embodiment.

FIG. 5 is a flowchart showing operations of the sound source position determination device according to the second embodiment.

FIG. 6 is a block diagram showing the configuration of a sound source position determination device according to a modified example.

FIG. 7 is a flowchart showing operations of the sound source position determination device according to the modified example.

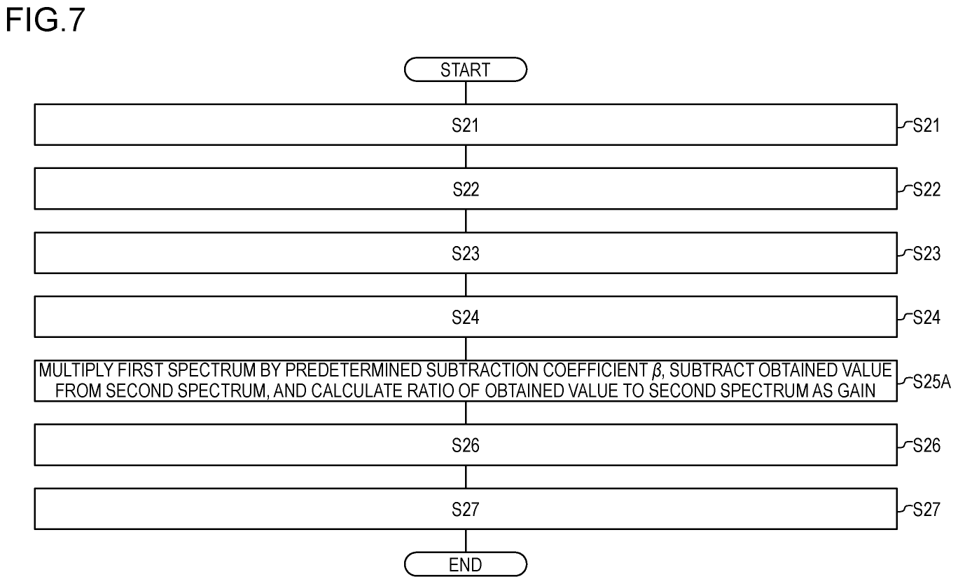

FIG. 8 is a block diagram showing the configuration of the sound source position determination device according to the third embodiment.

FIG. 9 is a block diagram showing the configuration of the sound source position determination device according to the fourth embodiment.

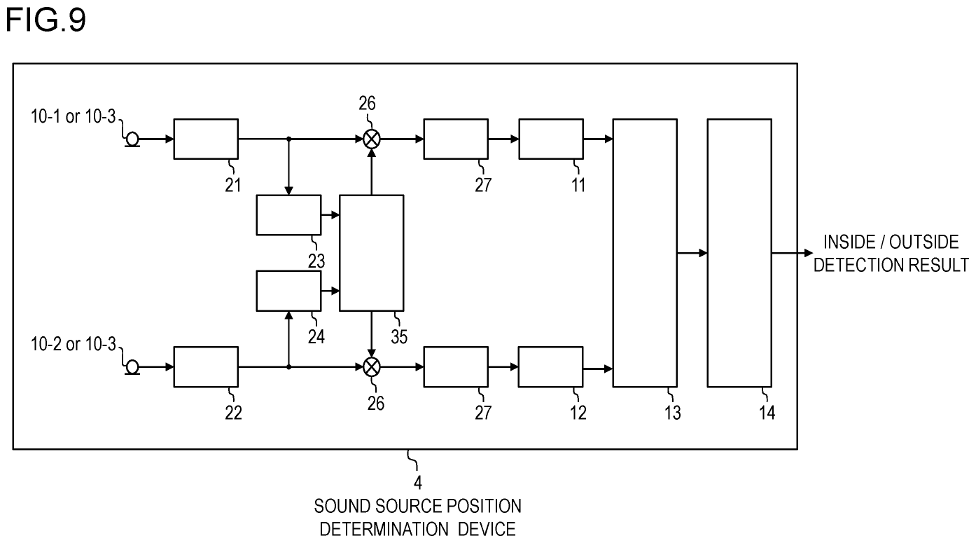

FIG. 10 is a diagram showing an exemplary function configuration of a computer.

### DESCRIPTION OF EMBODIMENTS

Embodiments of the present invention will be described below in detail. Note that constituent elements that have the same functions are given the same reference numerals, and a redundant description is omitted. Note that a sound source position determination device and a sound source position determination method of the embodiments to be described below can be used in general closed spaces. In the embodiments, a description will be given illustrating a vehicle as a closed space.

### First Embodiment

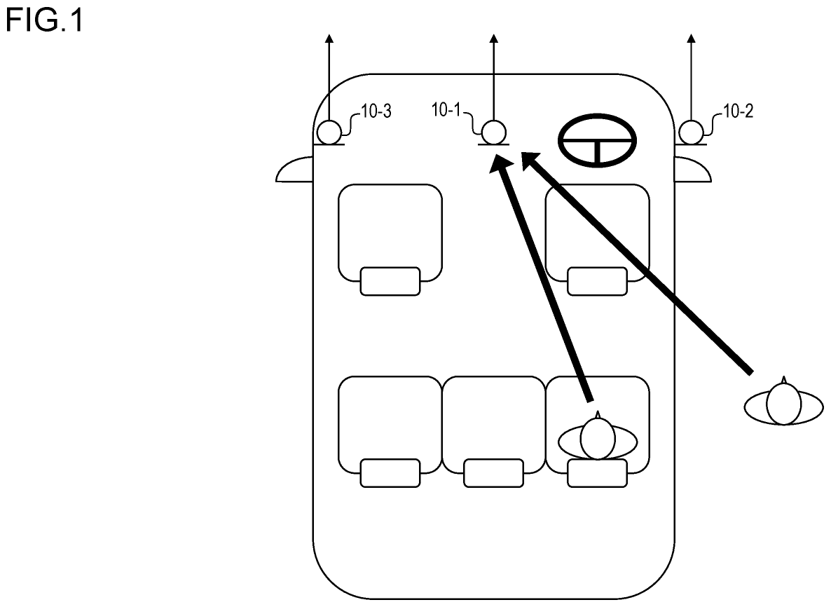

FIG. 1 shows an arrangement example of microphones of each sound source position determination device according to embodiments below. In the embodiments below, a microphone 10-1 in the vehicle, a microphone 10-2 outside the vehicle, and a vibration pickup 10-3 attached to a glass surface or a body in the vehicle (or microphone 10-3 attached to a glass surface or a body in the vehicle) are used. Since the microphone 10-1 installed in the vehicle is likely to pick up sound in the vehicle, and the microphone 10-2 installed outside the vehicle is likely to pick up sound outside the vehicle, it is possible to determine whether the target sound has been emitted inside or outside the vehicle by comparing the magnitudes of sound inside the vehicle and sound outside the vehicle. In addition, the vibration pickup 10-3 (or the microphone 10-3) attached to a glass surface or a body in the vehicle picks up sound emitted inside the vehicle and sound emitted outside the vehicle at approximately the same level. Using this, the magnitude of sound picked up by the vibration pickup 10-3 (or the microphone 10-3) attached to a glass surface or a body in the vehicle is compared with the magnitude of sound picked up by the microphone inside or outside the vehicle, and it is thereby possible to determine whether the sound was emitted inside or outside the vehicle.

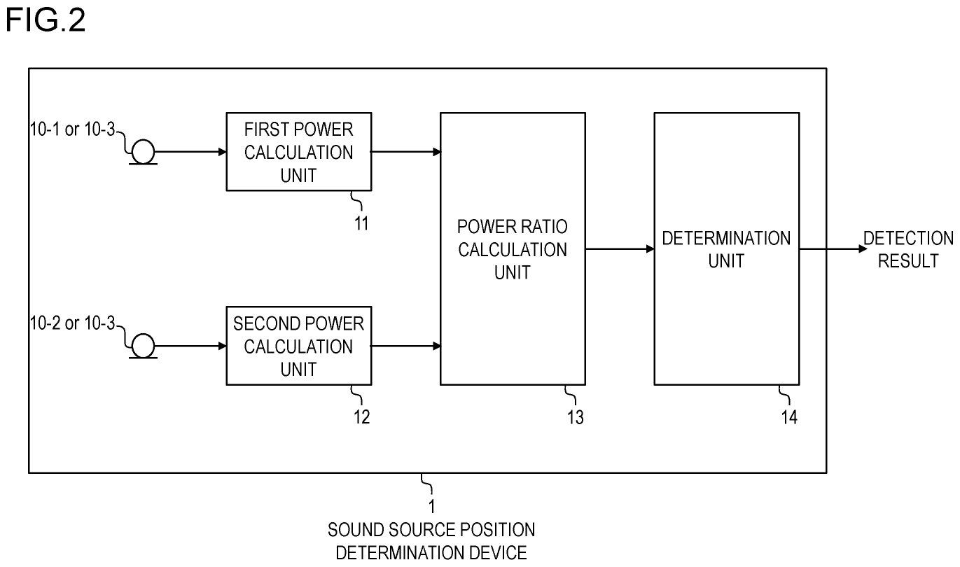

The configuration of the sound source position determination device according to the present embodiment will be described below with reference to FIG. 2. As shown in FIG. 2, a sound source position determination device 1 according to the present embodiment includes the microphone 10-1 (or 10-3) disposed at a position at which sound arriving from inside the vehicle is likely to be picked up, the microphone 10-2 (or 10-3) disposed at a position at which sound arriving from outside the vehicle is likely to be picked up, a first power calculation unit 11, a second power calculation unit 12, a power ratio calculation unit 13, and a determination unit 14.

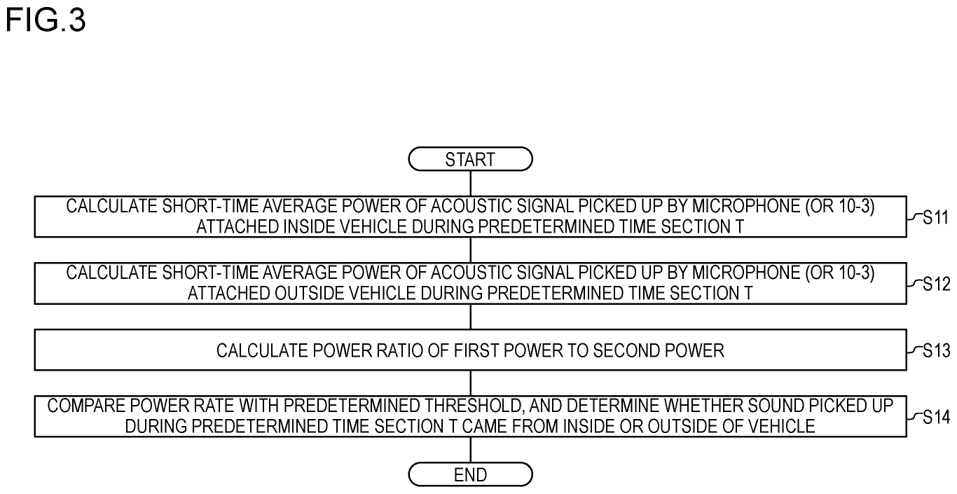

Operations of constituent elements of the sound source position determination device 1 according to the present embodiment will be described below with reference to FIG. 3. The first power calculation unit 11 calculates short-time average power (first power) of an acoustic signal picked up by the microphone 10-1 (or 10-3) attached inside the vehicle during a predetermined time section T, which is a time section in which signals are handled as signals picked up at the same time (step S11). Power at a discrete time t is calculated as average power of past N samples using the following expression, for example.

$${P}_{i} ( t ) = \frac{1}{N} {\sum }_{n = 0}^{N - 1} ( {x}_{i} ( t - n ) * {x}_{i} ( t - n ) ) \qquad [ Math . 1 ]$$

xᵢ(t): input signal at time t. Pᵢ(t): short-time average power, and N indicates time lengths (samples) to be averaged, and is set to the number of samples corresponding to approximately 100 ms to 10 s.

Similarly to the first power calculation unit 11, the second power calculation unit 12 calculates short-time average power (second power) of an acoustic signal picked up by the microphone 10-2 (or 10-3) installed outside the vehicle during the predetermined time section T, which is a time section in which signals are handled as signals picked up at the same time (step S12).

The power ratio calculation unit 13 calculates a power ratio of the first power to the second power (step S13).

The determination unit 14 compares the power ratio with a predetermined threshold value, and determines whether the sound picked up during the predetermined time section T came from inside or outside the vehicle, based on whether or not the power ratio exceeds the preset threshold value (step S14).

With the sound source position determination device 1 and a sound source position determination method according to the first embodiment, it is possible to determine whether a sound source corresponding to acoustic signals picked up by microphones installed on a vehicle is positioned inside or outside the vehicle.

### Second Embodiment

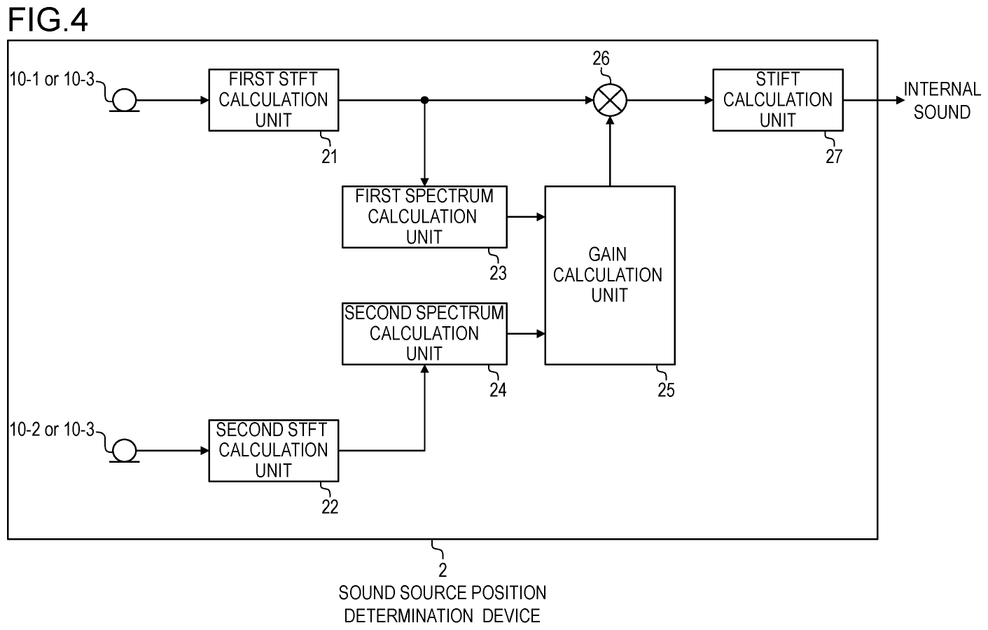

The configuration of a sound source position determination device according to a second embodiment will be described below with reference to FIG. 4. As shown in FIG. 4, a sound source position determination device 2 according to the present embodiment includes the microphone 10-1 (or 10-3) disposed at a position at which sound arriving from inside the vehicle is likely to be picked up, the microphone 10-2 (or 10-3) disposed at a position at which sound arriving from outside the vehicle is likely to be picked up, a first STFT calculation unit 21, a second STFT calculation unit 22, a first spectrum calculation unit 23, a second spectrum calculation unit 24, a gain calculation unit 25, a gain multiplication unit 26, and a STIFT calculation unit 27.

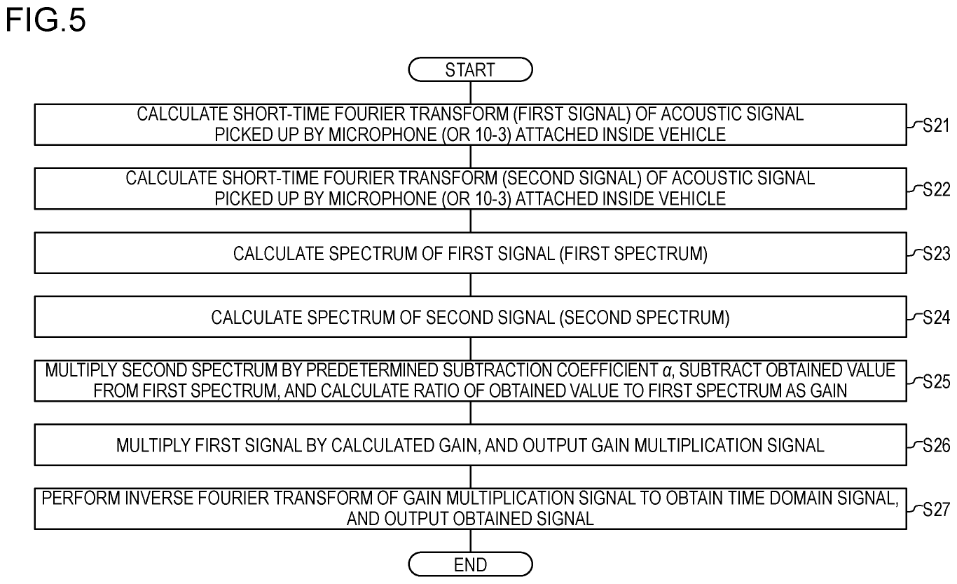

Operations of constituent elements of the sound source position determination device 2 according to the present embodiment will be described below with reference to FIG. 5. The first STFT calculation unit 21 calculates the short-time Fourier transform (first signal), which is a frequency domain representation, of an acoustic signal picked up by the microphone 10-1 (or 10-3) attached inside the vehicle (step S21). The first STFT calculation unit 21 may perform multiplication by the Hanning window or the like before performing short-time Fourier transform.

Similarly to the first STFT calculation unit 21, the second STFT calculation unit 22 calculates the short-time Fourier transform (second signal), which is a frequency domain representation, of an acoustic signal picked up by the microphone 10-2 (or 10-3) installed outside the vehicle (step S22).

The first spectrum calculation unit 23 calculates a spectrum of the first signal (first spectrum) (step S23). If a signal subjected to short-time Fourier transform is indicated by X(ω), a spectrum P(ω)=X(ω)². Note that X(ω) indicates a complex number of a microphone signal obtained through conversion into a frequency domain. ω indicates frequency. In addition, the power spectrum may be P(ω)=|X(ω)|.

Similarly to the first spectrum calculation unit 23, the second spectrum calculation unit 24 calculates a spectrum of the second signal (second spectrum) (step S24).

The gain calculation unit 25 multiplies a second spectrum Q(ω) by a predetermined subtraction coefficient α to obtain αQ(ω), subtracts αQ(ω) from the first spectrum P(ω) to obtain the value (S(ω)), and calculates the ratio of the value (S(ω)) to the first spectrum P(ω) as a gain G(ω) (step S25). The subtraction coefficient is a preset value, and takes a value of approximately 0.1 to 10.0. More specifically, the gain calculation unit 25 calculates the gain G(ω) based on the following expression.

S(ω)=P(ω)−α·Q(ω)

G(ω)=S(ω)/P(ω)

The gain multiplication unit 26 multiplies the first signal by the gain G(ω) calculated by the gain calculation unit 25, and outputs a gain multiplication signal (step S26).

The STIFT calculation unit 27 performs inverse Fourier transform on the gain multiplication signal to obtain a signal that is a time domain representation, and outputs the obtained signal as sound inside the vehicle (step S27).

With the sound source position determination device 2 and a sound source position determination method according to the second embodiment, it is possible to determine whether the sound source corresponding to acoustic signals picked up by the microphones installed on the vehicle is positioned inside or outside the vehicle. In addition, it is possible to realize improvement in the accuracy of a voice assistant and noise reduction for performing the aforementioned communication, by separating sound emitted from inside the vehicle and sound emitted from outside the vehicle from each other.

### Modified Example

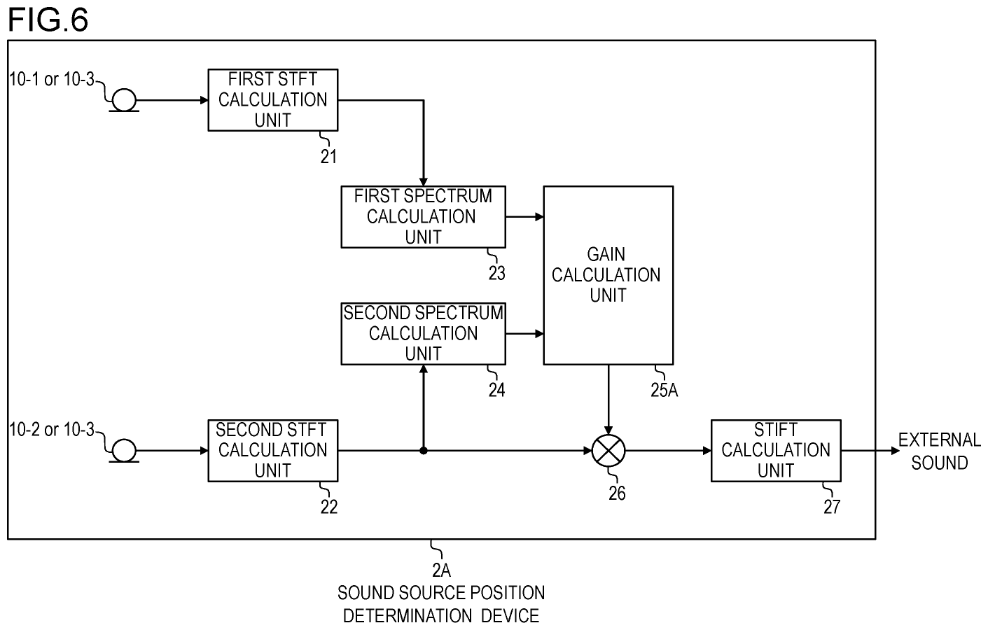

The configuration of a sound source position determination device 2A that extracts sound outside a vehicle by reversing the processing according to the second embodiment that is performed on a signal will be described below with reference to FIG. 6. As shown in FIG. 6, the sound source position determination device 2A according to this modified example includes the microphone 10-1 (or 10-3) disposed at a position at which sound arriving from inside the vehicle is likely to be picked up, the microphone 10-2 (or 10-3) positioned at a position at which sound arriving from outside the vehicle is likely to be picked up, the first STFT calculation unit 21, the second STFT calculation unit 22, the first spectrum calculation unit 23, the second spectrum calculation unit 24, a gain calculation unit 25A, the gain multiplication unit 26, and the STIFT calculation unit 27, and configurations other than that of the gain calculation unit 25A are similar to those of the sound source position determination device 2 according to the second embodiment.

The sound source position determination device 2A executes steps S21 to S24 similarly to the second embodiment. The gain calculation unit 25A multiplies the first spectrum P(ω) by a predetermined subtraction coefficient β to obtain βP(ω), subtracts βP(ω) from the second spectrum Q(ω) to obtain the value (S′(ω)), and calculates the ratio of the value (S′(ω)) to the second spectrum Q(ω) as a gain G′(ω) (step S25A). The subtraction coefficient is a preset value. More specifically, the gain calculation unit 25A calculates the gain G′(ω) based on the following expression.

S′(ω)=Q(ω)−β·P(ω)

G′(ω)=S′(ω)/Q(ω)

### Third Embodiment

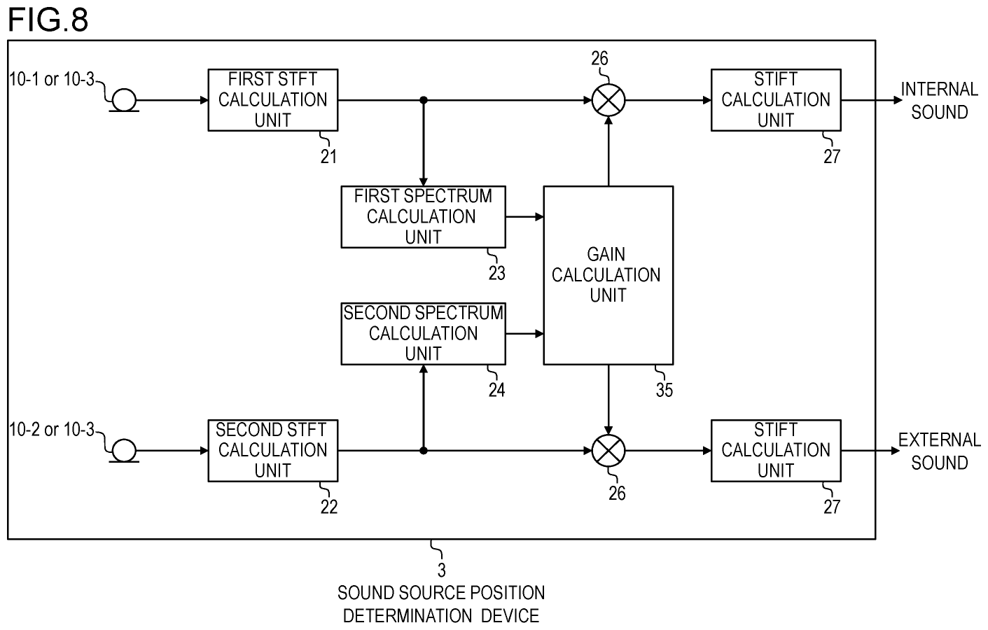

The configuration of a sound source position determination device 3 according to a third embodiment that can extract sound inside the vehicle and sound outside the vehicle at the same time, by combining the sound source position determination device 2 according to the second embodiment and the sound source position determination device 2A according to the modified example thereof will be described below with reference to FIG. 8. As shown in FIG. 8, the sound source position determination device 3 according to the present embodiment includes the microphone 10-1 (or 10-3) disposed at a position at which sound arriving from inside the vehicle is likely to be picked up, the microphone 10-2 (or 10-3) disposed at a position at which sound arriving from outside the vehicle is likely to be picked up, the first STFT calculation unit 21, the second STFT calculation unit 22, the first spectrum calculation unit 23, the second spectrum calculation unit 24, a gain calculation unit 35, two gain multiplication units 26 (one for extracting internal sound and the other for extracting external sound), and two STIFT calculation units 27 (one for extracting internal sound and the other for extracting external sound), and configurations other than that of the gain calculation unit 35 are similar to those of the sound source position determination device 2 according to the second embodiment or the sound source position determination device 2A according to the modified example of the second embodiment. The gain calculation unit 35 executes step S25 similarly to the second embodiment, and further executes step S25A similarly to the modified example (step S35).

Specifically, the gain calculation unit 35 multiplies the second spectrum Q(ω) by a predetermined subtraction coefficient α, subtracts the obtained value from the first spectrum P(ω) to obtain a value S(ω), and calculates the ratio of the value S(ω) to the first spectrum P(ω) as a first gain G(ω), and multiplies the first spectrum P(ω) by a predetermined subtraction coefficient β, subtracts the obtained value from the second spectrum Q(ω) to obtain a value S′(ω), and calculates the ratio of the value S′(ω) to the second spectrum Q(ω) as a second gain G′(ω) (step S35).

The STIFT calculation unit 27 outputs, as sound inside the vehicle, a signal that is a time domain representation of a first gain multiplication signal obtained by multiplying the first signal by the calculated first gain G(ω), and outputs, as sound outside the vehicle, a signal that is a time domain representation of a second gain multiplication signal obtained by multiplying the second signal by the calculated second gain G′(ω) (step S27). The remaining processing is similar to corresponding processing of the second embodiment or the modified example.

With the sound source position determination device 3 according to the third embodiment, it is sufficient to perform the same processing one time for the extraction of internal sound and the extraction of external sound, and thus it is possible to reduce the cost pertaining to the computation amount.

### Fourth Embodiment

A sound source position determination device 4 according to a fourth embodiment is configured by incorporating the sound source position determination device 3 according to the third embodiment in the first section of the sound source position determination device 1 according to the first embodiment.

Specifically, the power ratio calculation unit 13 calculates the power ratio of sound inside the vehicle to sound outside the vehicle, which was output in step S27 (step S13). The determination unit 14 determines, based on the power ratio, whether the sound picked up during the time section T came from inside or outside the vehicle (step S14).

With the sound source position determination device 4 according to the fourth embodiment, internal sound and external sound are extracted, and it is then determined whether the sound source is positioned inside or outside the vehicle, thus making it possible to more accurately perform the determination.

### SUPPLEMENTARY NOTE

As a single hardware entity for example, the device according to the present invention may include an input unit to which a keyboard or the like can be connected, an output unit to which a liquid crystal display or the like can be connected, a communication unit to which a communication device that enables communication with the outside of the hardware entity (for example, a communication cable) can be connected, a CPU (Central Processing Unit, which may include a cache memory, a register, and the like), a RAM and a ROM that are memories, an external storage device such as a hard disk, as well as a bus that connects the input unit, the output unit, the communication unit, the CPU, the RAM, the ROM, and the external storage device such that data can be exchanged between them. In addition, as necessary, such a hardware entity may be provided with a device (drive) that can read/write data from/to a recording medium such as a CD-ROM. A general-purpose computer is one example of a physical entity that includes such hardware resources.

The external storage device of the hardware entity stores a program required for realizing the aforementioned functions, data required for processing of this program, and the like (there is no limitation to the external storage device, and for example, such a program may be stored in a ROM that is a read-only storage device). In addition, data that is obtained as a result of the processing of such a program, and the like are stored in the RAM, the external storage device, or the like as appropriate.

In the hardware entity, programs stored in the external storage device (or the ROM, etc.) and data required for processing of the programs are loaded to a memory as necessary, and are interpreted, executed, and processed by the CPU as necessary. As a result, the CPU realizes predetermined functions (constituent elements described as the above units, means, and the like).

The present invention is not limited to the above embodiments, and modifications can be made as appropriate to the extent that they do not depart from the spirit of the invention. Moreover, processing described in the above embodiments may not only be executed chronologically in accordance with the written order but may also be executed in parallel or individually as required or according to the processing capacity of the device that executes the processing.

In the case where, as described above, processing functions of the hardware entity described in each of the above embodiments (device according to the present invention) are realized by a computer, the processing contents of the functions that the hardware entity is to be provided with are written as a program. The processing functions of the above hardware entity are realized on a computer by executing this program on the computer.

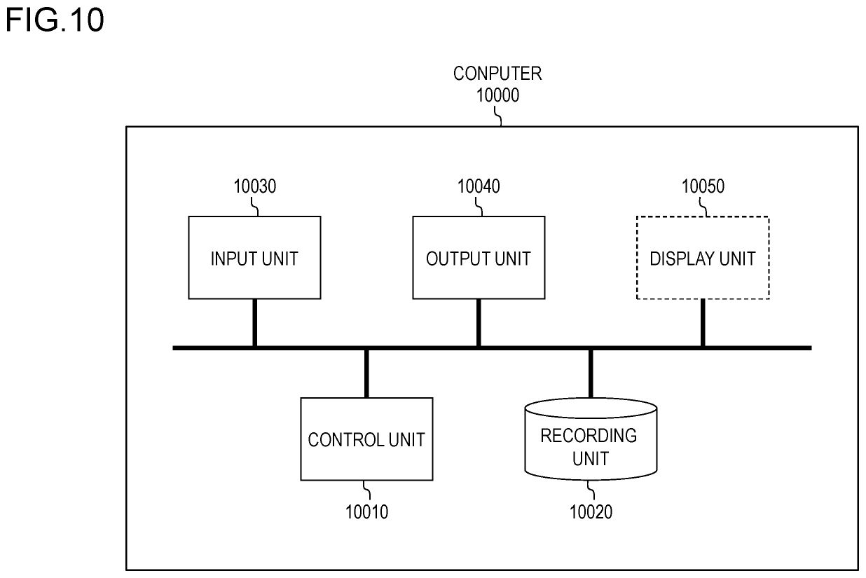

The aforementioned various types of processing can be carried out by causing a recording unit 10020 of the computer shown in FIG. 10 to load a program for executing steps of the above method, and causing a control unit 10010, an input unit 10030, an output unit 10040, or the like to operate.

A program on which this processing content is written can be recorded in a computer-readable recording medium. The computer-readable recording medium may be any recording medium such as a magnetic recording device, an optical disk, a magnetooptical recording medium, or a semiconductor memory. Specifically, for example, a hard disk device, a flexible disk, magnetic tape, or the like can be used as the magnetic recording device, a DVD (Digital Versatile Disc), a DVD-RAM (Random Access Memory), a CD-ROM (Compact Disc Read Only Memory), a CD-R (Recordable)/RW (Rewritable), or the like can be used as the optical disk, an MO (Magneto-Optical disc) or the like can be used as the magnetooptical recording medium, and an EEP-ROM (Electrically Erasable and Programmable-Read Only Memory) or the like can be used as the semiconductor memory.

Also, distribution of this program is performed by, for example, selling, transferring, or leasing a portable recording medium such as a DVD or a CD-ROM on which the program is recorded. Furthermore, a configuration may also be adopted in which this program is distributed by being stored on a storage device of a server computer, and transferred to other computers from the server computer via a network.

The computer that executes such a program first stores the program recorded on the portable recording medium or the program transferred from the server computer, temporarily in the storage device thereof. When processing is to be executed, this computer then loads the program stored in the recording medium thereof, and executes processing that conforms to the loaded program. Also, as other execution modes of the program, the computer may be configured to load the program directly from the portable recording medium and execute processing that conforms to the loaded program, and may also be configured such that, every time a program is transferred to the computer from the server computer, processing that conforms to the received program is executed. A configuration may also be adopted in which the program is not transferred to the computer from the server computer, and the above-mentioned processing is executed by a so-called ASP (Application Service Provider) service that realizes processing functions through only execution instructions and result acquisition. Note that a program in this mode includes information that is provided for use in processing by an electronic computer and is equivalent to a program (data, etc. that is not a direct instruction to the computer but has the characteristic of regulating processing to be performed by the computer).

Although in this mode the hardware entity is constituted by executing a predetermined program on a computer, at least some of the processing contents may be realized with hardware.

1. A sound source position determination device comprising:
a first microphone configured to be disposed at a position at which sound arriving from inside a closed space is likely to be picked up;
a second microphone configured to be disposed at a position at which sound arriving from outside the closed space is likely to be picked up;
processing circuitry configured to
calculate a power ratio of an acoustic signal picked up by the first microphone during a predetermined time section to an acoustic signal picked up by the second microphone during the predetermined time section, the predetermined time section being a time section in which signals are handled as signals picked up at the same time; and
determine whether sound picked up during the predetermined time section came from inside or outside the closed space, based on the power ratio.

2. A sound source position determination device comprising:
a first microphone configured to be disposed at a position at which sound arriving from inside a closed space is likely to be picked up;
a second microphone configured to be disposed at a position at which sound arriving from outside the closed space is likely to be picked up;
processing circuitry configured to
calculate a first spectrum that is a spectrum of a first signal that is a frequency domain representation of an acoustic signal picked up by the first microphone;
calculate a second spectrum that is a spectrum of a second signal that is a frequency domain representation of an acoustic signal picked up by the second microphone;
calculate a gain for emphasizing sound that came from inside the vehicle, using the first spectrum and the second spectrum; and
output, as sound inside the closed space, a signal that is a time domain representation of a gain multiplication signal obtained by multiplying the first signal by the calculated gain.

3. A sound source position determination device comprising:
a first microphone configured to be disposed at a position at which sound arriving from inside a closed space is likely to be picked up;
a second microphone configured to be disposed at a position at which sound arriving from outside the closed space is likely to be picked up;
processing circuitry configured to
calculate a first spectrum that is a spectrum of a first signal that is a frequency domain representation of an acoustic signal picked up by the first microphone;
calculate a second spectrum that is a spectrum of a second signal that is a frequency domain representation of an acoustic signal picked up by the second microphone;
calculate a gain for emphasizing sound that came from outside the vehicle, using the first spectrum and the second spectrum; and
output, as sound outside the closed space, a signal that is a time domain representation of a gain multiplication signal obtained by multiplying the second signal by the calculated gain.

4-6. (canceled)

7. A sound source position determination method that uses a first microphone configured to be disposed at a position at which sound arriving from inside a closed space is likely to be picked up and a second microphone configured to be disposed at a position at which sound arriving from outside the closed space is likely to be picked up, the method comprising:
a step of calculating a power ratio of an acoustic signal picked up by the first microphone during a predetermined time section to an acoustic signal picked up by the second microphone during the predetermined time section, the predetermined time section being a time section in which signals are handled as signals picked up at the same time; and
a step of determining whether sound picked up during the predetermined time section came from inside or outside the closed space, based on the power ratio.

8. A non-transitory computer-readable storage medium storing a program for causing a computer to function as the sound source position determination device according to claim 1.
